(19) United States
(12) Patent Application Publication
(10) Pub. No.: US 2024/0212021 A1
(43) Pub. Date: Jun. 27, 2024

(54) DEVICE OF PROVIDING CONTENT RECOMMENDATION INFORMATION BASED ON RELATIONSHIP LEARNING MODEL OF RENDERING INFORMATION AND METHOD OF OPERATING SAME

(71) Applicant: ARCHIDRAW. INC., Seoul (KR)

(72) Inventors: Ju Sung LEE, Gwangmyeong-si, Gyeonggi-do (KR); Jong Seon HONG, Seoul (KR)

(21) Appl. No.: 18/556,325

(22) PCT Filed: Aug. 19, 2022
(86) PCT No.: PCT/KR2022/012397

§ 371 Date: Oct. 19, 2023

(30) Foreign Application Priority Data
Aug. 19, 2021 (KR) 10-2021-0109556

(51) Int. Cl. G06Q 30/0601; G06V 20/64

(52) U.S. Cl. CPC G06Q 30/0631; G06V 20/64

(57) ABSTRACT

A method of operating a recommendation information providing device according to an embodiment of the present disclosure may include acquiring first user information; applying the first user information to a relationship learning model based on a rendering history corresponding to content; and providing content recommendation information corresponding to the first user information using the output information of the learning model.

### TECHNICAL FIELD

The present disclosure relates to a content recommendation information providing device and a method of operating the same. More specifically, the present disclosure relates to a device of providing content recommendation information based on a relationship learning model of rendering information and a method of operating the same.

### BACKGROUND ART

In recent years, with the development of various A/V media transmission and storage technologies, content that can be accessed by a user is exponentially increasing. In particular, as digital broadcasting and high-speed Internet infrastructure are introduced and various A/V devices increase in capacity, the user can enjoy a lot of content regardless of time and place. However, as the amount of content increases as described above, there is a problem in that it takes a lot of time and effort to search for what the user wants from among them, and thus studies on various content recommendation technologies have been carried out to solve the problem.

Describing conventional content recommendation methods, a method of typically classifying product meta information into keywords, and the like, and searching for content that matches or is similar to the meta information directly entered by the user in a content database to provide a content recommended list to the user, or a method of referring to pre-analyzed preferred keyword information and environment registration information in response to the user to automatically search for content that matches or is similar thereto, and generating a content recommended list from the searched content to provide the generated content recommended list to the user.

However, most of these methods need to recommend a variety of visually recognizable content using only simple text information such as the user's gender, age, address, and preferred keywords, and thus there is a problem in that cases where the user does not prefer occur very frequently, and therefore the accuracy appears to be quite low.

In particular, as the interior and furniture product content market has expanded in recent years, users desire to receive interior and furniture product content online, render the received content on their terminals, and easily decide on interior products or appropriate product combinations that suit their desired style to place an order online, and the demand is growing explosively along with an increase in the non-face-to-face market.

However, it is not easy to figure out what style users prefer using only conventional text-based classification analysis technologies as described above, and even if the style desired by a specific user is identified, it is difficult to figure out which products to combine and how to combine them with wallpaper, curtains, sofas, and the like, to achieve such styles in terms of the recommendation system.

### DISCLOSURE OF INVENTION

### Technical Problem

The present disclosure is contrived to solve the foregoing problems, and an aspect of the present disclosure is to provide a device of providing content recommendation information based on a relationship learning model of rendering information and a method of operating the same capable of constructing a relationship learning model based on a user's rendering history corresponding to the product content in advance, indexing content products or combinations of styles visually preferred by an actual user using the rendering history-based relationship learning model to accurately recommend them, and providing various additional services based thereon.

### Technical Solution

In order to solve the foregoing tasks, a method according to an embodiment of the present disclosure provides a method of operating a recommendation information providing device, the method including: acquiring first user information; applying the first user information to a relationship learning model based on a rendering history corresponding to content; and providing content recommendation information corresponding to the first user information using the output information of the learning model.

In addition in order to solve the foregoing tasks, a device according to an embodiment of the present disclosure provides a content recommendation information providing device, the device including: a user information collection unit that acquires first user information; a model-based recommendation data generation unit that applies the first user information to a relationship learning model based on a rendering history corresponding to content; and an information providing unit that provides content recommendation information corresponding to the first user information using the output information of the learning model.

In order to solve the foregoing problems, a method according to an embodiment of the present disclosure may be implemented as a computer program for executing the method on a computer, and a computer-readable recording medium on which the program is stored.

### Advantageous Effects

According to an embodiment of the present disclosure, a device of providing content recommendation information based on a relationship learning model of rendering information and a method of operating the same capable of constructing a relationship learning model based on a user's rendering history corresponding to the product content in advance, indexing content products or combinations of styles visually preferred by an actual user using the rendering history-based relationship learning model to accurately recommend them, and providing various additional services based thereon may be provided.

Furthermore, according to an embodiment of the present disclosure, the rendering history may be collected when users use a content rendering service, and relationship information learning based on visual feature information may be allowed in response to various rendering scenes and condition data acquired as users use the content service, thereby accurately identifying styles preferred by actual users rather than simple keyword classification using a learning model that reflects visual feature information, as well as providing a recommendation information providing and recommending service based thereon.

In addition, according to an embodiment of the present disclosure, using the rendering history-based relationship learning model, it may be possible to not only accurately provide indexing and recommendation of content or a combination thereof, but also recommend a rendering environment on a user terminal interface where the content is provided, thereby providing recommended content through a recommendation rendering environment that is predicted to be preferred by the user, which can improve service satisfaction of users who receive services using recommendation information.

### BRIEF DESCRIPTION OF THE DRAWINGS

FIG. 1 is a conceptual diagram schematically showing an overall system according to an embodiment of the present disclosure.

FIG. 2 is a block diagram showing in more detail a recommendation information providing device according to an embodiment of the present disclosure.

FIG. 3 is a block diagram showing in more detail a rendering history information processing unit according to an embodiment of silver present disclosure.

FIG. 4 is a flowchart for explaining an operation of a recommendation information providing device according to an embodiment of the present disclosure.

FIG. 5 is a diagram schematically explaining a process of constructing a relationship learning model based on a rendering history according to an embodiment of the present disclosure.

FIG. 6 is a flowchart for explaining an operation of a recommendation information providing device according to another embodiment of the present disclosure.

FIG. 7 is a diagram illustrating a rendering interface environment information table according to an embodiment of the present disclosure.

### BEST MODE FOR CARRYING OUT THE INVENTION

The following description illustrates the principles of the present disclosure. It will thus be appreciated that those skilled in the art will be able to devise various devices that, although not explicitly described or shown in this specification, implement the principles of the present disclosure and are included in the concept and scope of the present disclosure. Furthermore, it should be understood that all conditional terms and embodiments recited in this specification are intended only for pedagogical purposes to aid the reader in understanding the concept of the present disclosure, and are not limited to such specifically recited embodiments and conditions.

Moreover, it should be understood that all detailed description herein reciting the principles, aspects, and embodiments of the present disclosure as well as specific embodiments thereof are intended to encompass both structural and functional equivalents thereof. Additionally, it should be understood that such equivalents include both currently known equivalents as well as equivalents to be developed in the future, that is, any elements developed to perform the same function regardless of its structure.

Thus, for example, it should be understood that the block diagrams presented herein represent the conceptual view of an exemplary circuit that embodies the principles of the present disclosure. Similarly, it should be understood that any flow charts, flow diagrams, state transition diagrams, pseudocodes, and the like represent various processes which may be substantially represented in computer readable media and so executed by a computer or processor, whether or not such a computer or processor is explicitly shown.

The functions of various elements including a processor or a functional block represented as a concept similar thereto and shown in the accompanying drawings may be provided using hardware having a capability to execute appropriate software as well as dedicated hardware. When provided by the processor, the functions may be provided by a single dedicated processor, a single shared processor, or a plurality of individual processors, and some thereof may be shared with one another.

In addition, it should be understood that explicit use of the terms presented as processors, controls, or concepts similar thereto should not be interpreted by exclusively quoting hardware having an ability of executing software, and should be understood to implicitly include, without limitation, digital signal processor (DSP) hardware, and a ROM, a RAM and a non-volatile memory for storing software. Other known common hardware may also be included.

In the claims of this specification, an element expressed as a means for performing a function described in the detailed description is intended to include, for example, any method of performing a function including a combination of circuit elements or any form of software including firmware/microcode, and the like, which perform the function, and is combined with suitable circuitry for executing the software to perform the function. It should be understood that since functions provided by the various recited means are combined with one another and are combined with a scheme demanded by the claims in the present disclosure defined by the claims, any means capable of providing these functions are equivalent to means recognized from this specification.

The foregoing objects, features and advantages will be more obvious through the following detailed description associated with the accompanying drawings, and accordingly, the technological concept of the present disclosure can be easily implemented by a person having ordinary skill in the art to which the present disclosure pertains. In describing the present disclosure, moreover, the detailed description will be omitted when a specific description for publicly known technologies to which the present disclosure pertains is judged to obscure the gist of the present disclosure.

Hereinafter, a preferred embodiment according to the present disclosure will be described in detail with reference to the accompanying drawings.

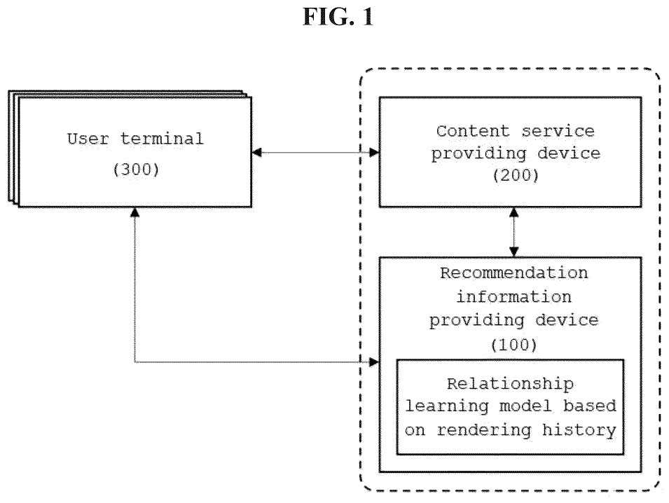

FIG. 1 is a diagram for schematically explaining an overall system according to an embodiment of the present disclosure.

First, a user terminal 300 described in this specification, which is one or more electronic devices that operate according to a user input to output a user interface associated with a content service and content rendered as video or image data, and various electronic devices such as a mobile phone, a smart phone, a computer, a laptop computer, a digital broadcasting terminal, a personal digital assistant (PDA), a portable multimedia player (PMP), a navigation device, a head mount display (HMD), a virtual reality device, an augmented reality device may be illustrated as examples.

Furthermore, the user terminal 300 may include a display unit, an audio output module, an alarm unit, a haptic module, and the like, and a service providing device 200 may output data for controlling the display unit, the audio output module, the alarm unit, the haptic module, and the like to the user terminal 300.

Furthermore, the display unit of the user terminal 300 may display a rendering interface for outputting rendering content according to an embodiment of the present disclosure. The display unit may include at least one of a liquid crystal display (LCD), a thin film transistor-liquid crystal display (TFT LCD), an organic light-emitting diode (OLED), and a flexible display, and a three-dimensional (3D) display.

Furthermore, a program or application for executing methods according to embodiments of the present disclosure may be installed to operate in the user terminal 300 in conjunction with the content service providing device 200 or a content recommendation information providing device 100.

In particular, the content service providing device 200 according to an embodiment of the present disclosure may store and manage information necessary to provide product content output from the user terminal 300 in a database, and provide rendering data and product content information at a request of the user terminal 300.

Here, the product content information may include various product information or a combination thereof, which may be, for example, a specific product or a combination of product groups corresponding to a specific style, and may be rendered in various ways through a rendering interface of the user terminal 300 and displayed visually to the user.

In addition, the rendering interface may provide a display interface that displays product content as viewed from a specific angle according to the user's input, and vary the rendering angle, illumination, atmosphere, color, and the like according to the user's interface input manipulation to output the rendered content through the output unit of the user terminal 300.

Furthermore, the output unit of the user terminal 300 may be processed and output in a rendering environment of various formats according to the interface input of the user terminal 300, and at least one of an augmented reality (AR) environment that outputs content mixed with actual reality images, a virtual reality (VR) environment that outputs content mixed with virtual reality images, and a two-dimensional display interface environment that outputs content on a two-dimensional display screen.

Accordingly, the content service providing device 200 according to an embodiment of the present disclosure may provide a rendering service associated with product content to the user terminal 300, and provide a payment service that performs content purchase processing for the user terminal 300 by entering payment information corresponding to the product content.

According to such a system configuration, on the user terminal 300, the user may experience a product he or she wants through the use of the content service providing device 200 through rendered content through the virtual reality, augmented reality, or two-dimensional display interface environments, and perform purchase processing through entering payment information. Moreover, the content service providing device 200 may perform delivery processing of the purchased product, and the user may additionally input product feedback information, preference information, and the like, corresponding to the purchased product on the user terminal 300.

In addition, the recommendation information providing device 100 according to an embodiment of the present disclosure may collect rendering history information from content service providing environment data in the user terminal 300, and construct a relationship learning model in advance for content recommendation based on the collected rendering history information.

Here, the relationship learning model may include a model in which rendering-based visual feature information of the content according to the provision of the content service is pre-trained in response to metadata feature information and user metadata of the content.

Here, the metadata feature information of the content may be consist of at least one of rendering condition metadata acquired in connection with the rendering of the content, model information metadata corresponding to the content, and product information metadata corresponding to the content, and the user metadata may include at least one of user basic information collected in response to the content, rendering interface input information corresponding to the user basic information, preference input information, purchase input information, evaluation input information, and category input information.

Furthermore, the rendering-based visual feature information of the content may include a visual feature vector acquired by applying one or more rendering images acquired in response to the content to a pre-constructed deep learning network, which may be used as important information to predict what visual characteristics the content has and in what manner the content is visualized that the user prefers.

For example, the rendering image may include an image in which the content or a scene image including the content is rendered for each preset three-dimensional viewpoint, and the visual feature information may include a visual feature vector extracted from the deep learning network according to geometric structure information and color information according to the three-dimensional viewpoint of the rendering image.

Here, an example of a deep learning network that extracts visual feature vectors may be illustrated as a ResNet network that is trained to vectorize and extract visual feature information from images by applying a convolution neural network (CNN) model thereto. ResNet, which is a method announced by Microsoft that improves the efficiency of weight update-based residual learning by applying identity mapping and skip connection to the CNN model, is a method that is effectively used for analyzing feature information of images.

Accordingly, the recommendation information providing device 100 may perform learning to associate the visual feature vector extracted in this manner with content rendering metadata and user metadata of rendering history information. To perform training, for example, a neural network may be set up according to a deep learning algorithm based on a deep neural network (DNN), and the neural network may use a variety of typical learning models consisting of an input layer, one or more hidden layers, and an output layer.

Here, a neural network other than DNN may be applied to the deep learning algorithm, and for an example, a neural network such as a convolution neural network (CNN) or a recurrent neural network (RNN) may be applied, and moreover, a deep learning model based on long-short term memory (LSTM), which is an improved version of the neural networks, or a partial combination model thereof may also be used.

In addition, the content rendering metadata and user metadata of the rendering history information may be one-hot encoded and learned as input information of the relationship learning model as preprocessed vector information, and the output information may be a numerical value of a correlation between the content rendering metadata of the rendering history information and the visual feature vector corresponding to the user metadata.

Accordingly, the recommendation information providing device 100 may perform learning by applying actual rendering history information collected through the user terminal 300 or the content service providing device 200 to a rendering history-based relationship learning model corresponding to each content, and provide content recommendation information corresponding to the first user information using the output information of the learning model to which the first user information is applied when first user information of the new user terminal 300 is input after the learning is performed.

Here, the output information of the learning model may be different depending on the configuration of the first user information, but is preferably consists of visual feature information whose correlation is predicted to be greater than a threshold and content rendering metadata by entering user metadata corresponding to the first user information.

Accordingly, the recommendation information providing device 100 may configure content recommendation information including highly correlated visual feature information and content rendering metadata, and provide the configured content recommendation information to the content service providing device 200 or directly to the user terminal 300.

As a result, the content recommendation information may include recommended product content or combination content of the recommended products that matches the user's preferred visual feature, and the recommended product content or the combination content of recommended products may be output from the user terminal 300 in the form of a recommended item list consisting of one or more recommended items.

For example, the content service providing device 200 may index recommended products or recommended interior items in a database in response to recommended visual feature information and recommendation rendering metadata provided by the recommendation information providing device 100, configure recommended item list information corresponding to the first user information using the recommended products or recommended interior items, and provide the recommended item list information to the user terminal 300 corresponding to the first user information.

Moreover, in order to increase service satisfaction based on visual features, the content service providing device 200 may identify rendering interface condition information corresponding to each item in the recommended item list from the recommendation rendering metadata provided by the recommendation information providing device 100, and provide the rendering interface condition information to the user terminal 300.

Accordingly, the user terminal 300 may process the recommended item selected by the user to be output through a rendering environment constructed according to the rendering interface condition information.

Here, the rendering environment may include at least one rendering environment from among an augmented reality (AR) environment that outputs content mixed with actual reality images, a virtual reality (VR) environment that outputs content mixed with virtual reality images, and a two-dimensional display interface environment that outputs content on a two-dimensional display screen, and the user terminal 300 may determine at least one environment from among an augmented reality environment, a virtual reality environment, and a two-dimensional display interface environment based on rendering interface condition information, and process content to be provided through an environment that the user visually prefers.

Furthermore, the rendering environment may be processed to be a mixed environment. For example, the rendering interface condition information may have weights set to 30% for augmented reality, 60% for virtual reality, and 10% for two-dimensional display, and may be output in a mixed manner in the form that can be switched by the user depending on whether the user terminal 300 supports rendering. In this case, the weight may indicate the priority of the rendering environment according to user preference, and the user terminal 300 may preferentially or sequentially render at least one of an augmented reality environment, a virtual reality environment, and a two-dimensional display interface environment, and convert the output environment according to a user input.

Meanwhile, the recommendation information providing device 100 may be connected to the content service providing device 200 or the user information collection unit 115 through a wired/wireless network, and each element may be provided with one or more wired or wireless communication modules for performing communication through the wired/wireless network. The wired/wireless communication network may use various widely known communication methods.

Accordingly, the recommendation information providing device 100 according to an embodiment of the present disclosure may construct a relationship learning model based on a user's rendering history corresponding to the product content in advance, index content products or combinations of styles visually preferred by an actual user using the rendering history-based relationship learning model to accurately recommend them, and provide content recommendation information based on a relationship learning model of rendering information that can provide various additional services based thereon.

Meanwhile, the content service providing device 200 may provide history information to the recommendation information providing device 100 or acquire recommendation information according to the provision of first user information to process a recommended item indexing and providing service described according to an embodiment of the present disclosure, and although it is described as a separate device from the recommendation information providing device 100, the content service providing device 200 may be configured to be combined with the recommendation information providing device 100 as a single server device. Accordingly, it may be possible to construct a service providing system network that combines the functions of the recommendation information providing device 100 and the content service providing device 200 according to an embodiment of the present disclosure.

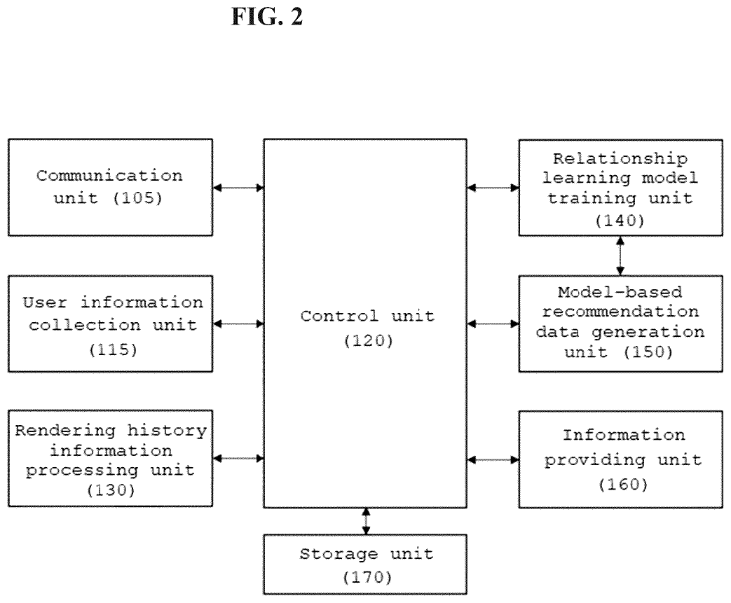

FIG. 2 is a block diagram showing in more detail a recommendation information providing device according to an embodiment of the present disclosure.

First, referring to FIG. 2, the recommendation information providing device 100 includes a communication unit 105, a user information collection unit 115, a control unit 120, a rendering history information processing unit 130, a relationship learning model training unit 140, a model-based recommendation data generation unit 150, an information providing unit 160, and a storage unit 170. The elements shown in FIG. 2 are not essential, and a device may be implemented to include more or fewer elements than those shown in FIG. 2.

First, the control unit 120 controls an overall operation of the recommendation information providing device 100. The control unit 120 may include one or more microprocessors configured to allow the recommendation information providing device 100 to apply the first user information to a relationship learning model based on rendering history corresponding to content, and provide content recommendation information corresponding to the first user information using the output information of the learning model.

In addition, the communication unit 105 may include one or more modules that enable wired/wireless communication over a network between the recommendation information providing device 100 and the content service providing device 200 or over a network between the recommendation information providing device 100 and the user terminal 300.

For example, the communication unit 105 may include a mobile communication module, a wired/wireless Internet module, a short-range communication module, and a location information module. The mobile communication module transmits and receives wireless signals to and from at least one of a server device, a base station, an external terminal, and a server on a mobile communication network. The wired/wireless Internet module refers to a module for wired/wireless Internet access, and may be built into or external to the recommendation information providing device 100. For wired/wireless Internet technologies, Local Area Network (LAN), Wireless LAN (WLAN), Wi-Fi, Wireless broadband (Wibro), World Interoperability for Microwave Access (Wimax), High Speed Downlink Packet Access (HSDPA), or the like may be used. The short-range communication module refers to a module for short-range communication. For short range communication technologies, Bluetooth, Radio Frequency Identification (RFID), Infrared Data Association (IrDA), Ultra Wideband (UWB), ZigBee, or the like may be used. The location information module, which is a module for acquiring the location of the terminal, and a representative example thereof is a Global Position System (GPS) module.

The user information collection unit 115 collects user information corresponding to specific content from the user terminal 300 or the content service providing device 200. The user information may be received through the communication unit 105, and the user information collection unit 115 may process user metadata from the user information, and transmit the processed user metadata to the rendering history information processing unit 130.

More specifically, the user information may be processed into user metadata included as an element of rendering history information used to train a relationship learning model of content. The user metadata may include at least one of basic user information collected in response to content, rendering interface input information of the content corresponding to the basic user information, preference input information, purchase input information, evaluation input information, and category input information.

The basic user information may include basic type information that can be collected through an external system, such as gender information, age information, region information, social network identification information, and preference style survey information.

In addition, the rendering interface input information may include input information entered by the user with respect to the content in response to the content rendering interface output through the aforementioned user terminal 300. Here, the input information may include various interface input information such as render shot input information that is input for content service rendering, AR mode input information, VR mode input information, panorama mode input information, 360-degree display view input information, 720-degree display view input information, and the like.

Furthermore, the preference input information, purchase input information, evaluation input information, and category input information, which are information entered in response to specific content through the user terminal 300, may be converted into separately assigned classification values or keywords.

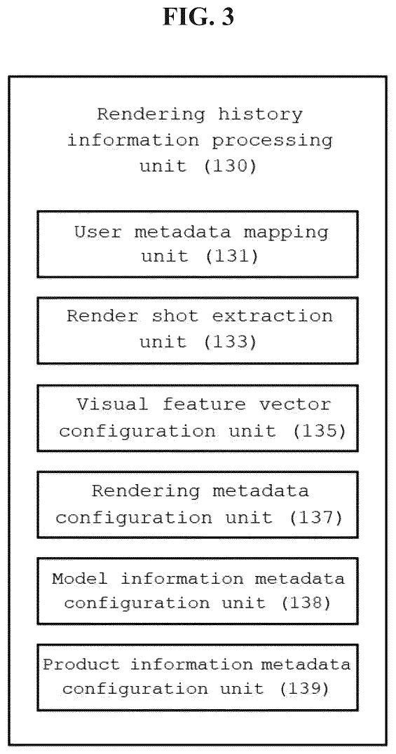

In addition, the user information collection unit 115 may transmit the collected user metadata to the rendering history information processing unit 130. Hereinafter, the rendering history information processing unit 130 will be described in more detail with reference to FIG. 3.

FIG. 3 is a block diagram showing in more detail a rendering history information processing unit according to an embodiment of silver present disclosure.

More specifically, the rendering history information processing unit 130 may include a user metadata mapping unit 131, a render shot extraction unit 133, a visual feature vector configuration unit 135, a rendering metadata configuration unit 137, a model information metadata configuration unit 138, and a product information metadata configuration unit 139.

The rendering history information processing unit 130 may collect rendering information corresponding to the content through the communication unit 105 and configure the collected rendering information as rendering history information. The rendering history information may be mapped to the aforementioned user metadata through the user metadata mapping unit 131, and may include content rendering metadata feature information and rendering-based visual feature information of the content, which are acquired in connection with rendering of the content in the user terminal 300.

First, the render shot extraction unit 133 extracts one or more rendering images acquired in response to the content to transmit the extracted rendering images to the visual feature vector configuration unit 135.

In addition, the visual feature vector configuration unit 135 may output the visual feature vector of the content acquired by applying the rendering image to a deep learning network to the relationship learning model training unit 140.

Here, the one or more rendering images may include images in which the content or a scene image including the content is rendered for each preset three-dimensional viewpoint, and the visual feature information may include a visual feature vector extracted from the deep learning network according to geometric structure information and color information according to the three-dimensional viewpoint of the rendering image.

More specifically, the rendering image from which the visual feature vector is extracted may be acquired from the render shot extraction unit 133, which may include a rendered image of a realistic and reality-like scene image for content provided through the user terminal 300. For example, the user terminal 300 may output rendered image data of virtual space interior content corresponding to a three-dimensional indoor structure, and the rendered image data may be a three-dimensional image projected in response to a first viewpoint that is set to correspond to the virtual space interior, and may be image data to which one or more rendering effect calculation processes for implementing a realistic scene are applied.

The render shot extraction unit 133 according to an embodiment of the present disclosure may extract the image data for which the rendering effect is calculated as the rendering image.

More specifically, the rendering effect may include effect processing that applies well-known global illumination-based shader algorithms to 3D data. Rendering techniques based on global illumination provide a more physical and sophisticated interpretation of an interaction between light and media. The global illumination may give a more realistic feel by calculating both direct light from a light source and indirect light reflected from other materials, objects, walls, and the like, and phenomena such as soft shadows, caustics, and color bleeding may all appear through a global illumination effect.

Since this global illumination effect as a method of simulating the phenomenon of light movement in the real world as it is requires a very high calculation amount, the content service providing device 200 according to an embodiment of the present disclosure may allow cloud devices (not shown) to perform a ray tracing process based on global illumination in a distributed manner using a cloud-based rendering service network consisting of one or more cloud devices (not shown), thereby effectively constructing rendered 3D virtual space interior content. This is based on a rendering optimization process of the content service providing device 200 that effectively shares computing resources and efficiently reduces a calculation time.

Accordingly, the content service providing device 200 may be a master device that configures a realistic scene rendering task into partial image rendering tasks in a distributed manner and assigns them to a cloud device (not shown), and the cloud device (not shown) may be a slave device that processes partial image rendering and transmits an optimized realistic scene partial image to the content service providing device 200. The service providing device 200 according to an embodiment of the present disclosure may configure distributed processing data that is optimized for realistic distributed rendering processing of scene images projected to a first viewpoint in response to three-dimensional virtual space interior content to be provided to the user terminal 300, transmit the configured distributed processing data to one or more cloud devices (not shown) connected to a rendering service network, receive distributively rendered realistic scene partial images from the cloud device (not shown), and configure a realistic scene image from the first viewpoint corresponding to the three-dimensional virtual space interior content.

The resultant configured realistic scene image of the first viewpoint may be provided to the user terminal 300, and by repeatedly performing pre-rendering, the first viewpoint may be extended to a plurality of viewpoints. Moreover, the plurality of viewpoints may consist of omnidirectional point viewpoints corresponding to a three-dimensional virtual space, and 720-degree omnidirectional virtual space interior content processed with realistic scene images can be provided depending on the optimization of pre-rendering and the improvement of cloud network performance.

Besides, the content service providing device 200 according to an embodiment of the present disclosure may provide an object conversion service within a realistic scene image, and for this purpose, realistic scene images converted into a plurality of objects are generated in advance and stored and managed in a database. For example, realistic scene image processing, such as changing furniture to a different type within specific virtual space interior content, may be easily provided through a pre-rendering process. Furthermore, the service providing device 100 according to an embodiment of the present disclosure may determine a partially converted boundary region corresponding to a range of influence due to object conversion in response to a first object prior to conversion and a second object subsequent to conversion, perform only realistic scene image re-rendering processing corresponding to the partially converted boundary region, and combine the re-rendered scene image portion with the remaining existing scene image portion to generate a realistic scene image in which the first object is converted to the second object, thereby providing object conversion processing that minimizes a calculation amount in a recalculation process while preventing any sense of difference.

In addition, the visual feature vector configuration unit 135 according to an embodiment of the present disclosure may acquire rendering image information of content provided by the user terminal 300 from the render shot extraction unit 133 through realistic scene image processing or the like as described above, configure the acquired rendering image information as input data, and apply the input data to a pre-trained image-based vector feature information extraction model to acquire an image-based visual feature vector.

Furthermore, for example, in the case of three-dimensionally modeled rendering data, the visual feature vector configuration unit 135 may process visual information seen from various angles into a rendering image, and acquire a visual feature vector corresponding to one piece of content using a plurality of rendering images.

Here, the pre-trained image-based vector feature information extraction model may be illustrated as a prediction model that extracts visual feature vectors through a deep learning network pre-trained using, for example, ImageNet sample data (approximately 1.2 million images) proposed by Google.

A top layer of this pre-trained deep learning network may be classified as a layer for converging to a final classification value, and when all remaining layers except the layer are constructed with the foregoing ResNet-based deep learning network, for example, a 1024-dimensional visual feature vector may be extracted. Such a visual feature vector may include a feature vector that complexly represents geometric structures and color elements that view the content from various angles, and this may be transmitted to the relationship learning model training unit 140 to be used for training the relationship learning model.

Meanwhile, the rendering metadata configuration unit 137 preprocesses the rendering metadata feature information of the content to transmit the preprocessed feature information to the relationship learning model training unit 140.

Here, the content rendering metadata feature information may be configured from at least one of rendering condition metadata acquired in connection with the rendering of the content, model information metadata corresponding to the content, and product information metadata corresponding to the content.

The rendering condition metadata may include rendering condition information used for the rendering of the content according to a user input on the user terminal 300. The rendering condition metadata may be used to calculate a correlation with user metadata rendering condition information.

Such rendering condition metadata may include first metadata corresponding to a detailed attribute of the content, second metadata corresponding to a rendering condition of the content, and third metadata corresponding to a surrounding environment in which the content is rendered.

The first metadata may include at least one of a length, a color, a category, and a type corresponding to the detailed attribute of the content. For example, the first metadata may be determined according to length dimension, color, category, type, or a combination thereof of a product included in the content previously output from the user terminal 300. Furthermore, the first metadata may be, for example, a length combination, a color combination, a category combination, a type combination, and the like, of products included in the content.

For example, when the content corresponds to an interior product, the first metadata may include one or more classification identification information determined by 50 cm×10 cm×50 cm in width×length×height for the length dimension, brown for the color, an ornament for the category, and any one of a floor-standing type, a wall-mounted type, and a ceiling type for the type. Furthermore, for example, when the content corresponds to an interior combination style, the first metadata may further include the combination information of first metadata calculated in response to a plurality of interiors.

Meanwhile, the second metadata may include at least one of whether it is virtual reality rendering, whether it is augmented reality rendering, an illumination condition, a camera position, a camera focus, a camera angle, and whether it is composite scene content corresponding to the rendering state of the content. The second metadata is determined by analyzing the rendering state of the content output from the user terminal 300, and for this purpose, the user terminal 300 may collect rendering state information for each content, and provide the collected information through the content service providing device 200 or directly to the recommendation information providing device 100.

Accordingly, from among the second metadata, whether it is virtual reality rendering, whether it is augmented reality rendering, an illumination condition, a camera position, a camera focus, a camera angle, and the like may numerically indicate in which rendering environment the rendered content has been mainly output on the user terminal 300. In addition, information on whether it is composite scene content may include code information that distinguishes whether the content is output in combination with other content or output or as separate, independent content on the user terminal 300.

In addition, the third metadata may include at least one of region type information, region size information, and region material indexing information corresponding to the rendered surrounding environment. The third metadata may include, for example, rendered region information, may include, when the region is a room implemented with an interior, an attribute information code corresponding to the room (e.g., living room-0, bedroom-1, bathroom-2, etc.), may include numerical information on an area of the room, and may include material information corresponding to walls and a floor as indexing information.

Meanwhile, the model information metadata configuration unit 138 may configure model information metadata from model feature information extracted from the model data of the content itself, and the configured model information metadata may be included in or mapped to the rendering condition metadata and transmitted to the relationship learning model training unit 140. The model information metadata may include, for example, model format information, object feature information, surface feature information, line feature information, data size information, object number information, or rendering calculation amount information that configures three-dimensional model information of interior content.

In addition, the product information metadata configuration unit 138 may configure product information metadata extracted from product information corresponding to content, and the configured product feature information metadata may be included in or mapped to the rendering condition metadata and transmitted to the relationship learning model training unit 140. For example, the product information metadata may be illustrated as product specification information, dimension information, price information, sales popularity information, seller information, and sales volume information of interior content.

Accordingly, the rendering history information processing unit 130 may extract rendering-based visual feature information of the content according to the provision of content services through the user terminal 300, and acquire the rendering metadata feature information of the content corresponding thereto and user metadata, and the acquired information may be preprocessed and input into the relationship learning model training unit 140. Here, the preprocessing process may include a process of vectorizing the rendering-based visual feature information of the content, and a conversion process of converting the metadata feature information of the content and user metadata into a one-hot encoded vector matrix. The preprocessing process may further include a filtering process as needed.

Meanwhile, the remaining configurations of the recommendation information providing device 100 will be described again with reference to FIG. 2.

Referring to FIG. 2, the relationship learning model training unit 140 constructs a learning model in which relationship information based on rendering history corresponding to content is trained by training and processing the rendering-based visual feature information of the content in advance according to the provision of the content service provided through the rendering history information processing unit 130 in response to the metadata feature information and user metadata of the content.

Accordingly, the relationship learning model training unit 140, in response to the visual feature information of the above-described content, may construct a learning model for training a degree of relationship between the rendering-based metadata feature information and the user metadata of the content acquired as a result of rendering content by an actual user.

To perform training on the relationship learning model training unit 140, as described above, a neural network may be set up according to a deep learning algorithm based on a deep neural network (DNN), and the neural network may use a variety of typical learning models consisting of an input layer, one or more hidden layers, and an output layer. Here, a neural network other than DNN may be applied to the deep learning algorithm, and for an example, a neural network such as a convolution neural network (CNN) or a recurrent neural network (RNN) may be applied, and moreover, a deep learning model based on long-short term memory (LSTM), which is an improved version of the neural networks, or a partial combination model thereof may also be used.

By performing training as described above, rendering-based content rendering metadata and user metadata that are highly relevant to each visual feature information may be trained and processed in advance. As a result, when any certain user metadata corresponding to a specific user is input, it means that content rendering metadata with a high degree of relationship, visual feature information, and the remaining user metadata may be acquired from the relationship learning model in response thereto.

That is, unlike conventional user preference keywords simply entered or simple click input analysis, the rendering-based visual features of content that actual users may prefer and the content rendering metadata required to implement that rendering may be confirmed, and furthermore, the remaining user metadata except for certain user metadata used in input may also be confirmed, and therefore, the preferred price, preference, style, category, interface input, and the like, of content preferred by a specific user may also be predicted as user metadata.

When the training of the relationship learning model is completed, the model-based recommendation data generation unit 150 acquires recommendation information based on the trained relationship learning model by entering the first user information provided from the content service providing device 200 or the user terminal 300, and generates recommendation data based on the acquired recommendation information.

In addition, the information providing unit 160 may process content recommendation information corresponding to the recommendation data to provide the processed content recommendation information to the content service providing device 200 or the user terminal 300.

Here, the recommendation information may include the content rendering metadata and the visual feature information of the content acquired by applying the first user information to the relationship learning model, and may further include the remaining user metadata when the first user information is part of the user metadata.

For example, the information providing unit 160 may acquire recommended visual feature data and recommended content rendering metadata generated by the model-based recommendation data generating unit 150 and provide them to the service providing device 200.

In addition, the service providing device 200 may index recommended products or recommended interior items that have high similarity to the visual feature information or content rendering metadata of the preprocessed products or interior items based on the recommended visual feature data and the recommended content rendering metadata, configure recommended item list information corresponding to the first user information using the recommended products or recommended interior items, and provide the recommended item list information to the user terminal 300 corresponding to the first user information. However, this is an example of a case where the service providing device 200 is separated, and the above process may also be performed in the recommendation information providing device 100 through the information providing unit 160.

According to this configuration, based on direct and indirect rendering information of the content, the preferred visual features and product combinations for each customer's user metadata may be trained and processed in advance as a relationship learning model, thereby providing a recommendation information service that can recommend more accurate and personalized content, as well as a product and content recommendation service based thereon.

For example, the recommendation information providing device 100 according to an embodiment of the present disclosure may allow the user's subjective tendencies, and the like that are difficult to acquire, only with simple keyword information, to be identified in advance in a situation where various customer tastes and preferred styles can be infinitely combined, such as home interior, or the like, improve the satisfaction of using the content, as well as reduce the customer's product indexing time and increase the efficiency of purchasing as the identified home interior product group is rendered and provided according to the prediction of the customer's visual preference, thereby allowing the provision and expansion of effective services.

Meanwhile, the storage unit 170 may store a program for operating the control unit 120, and also temporarily store input/output data.

The storage unit 170 may include a storage medium having at least one type of a flash memory type, a hard disk type, a multimedia card micro type, a card type memory (e.g., SD or XD memory, etc.), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk. The recommendation information providing device 100 may operate in connection with a web storage that performs a storage function of the storage unit 170 on the Internet.

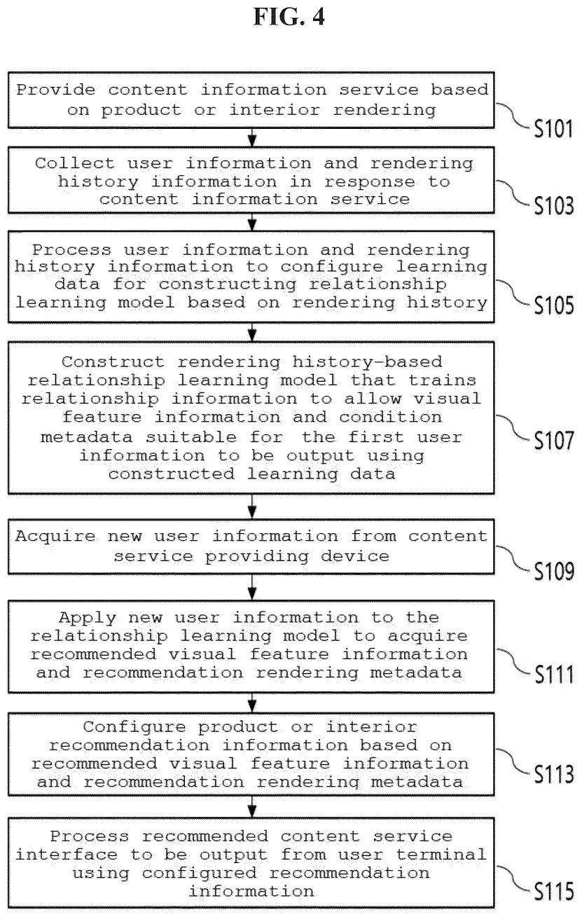

FIG. 4 is a flowchart for explaining an operation of a recommendation information providing device according to an embodiment of the present disclosure.

Referring to FIG. 4, the content service providing device 200 according to an embodiment of the present disclosure first provides a content information service based on product or interior rendering to the user terminal 300 (S101).

Then, the recommendation information providing device 100 collects user information and rendering history information in response to the content information service (S103).

Thereafter, the recommendation information providing device 100 processes user information and rendering history information to configure learning data for constructing a relationship learning model based on rendering history (S105).

As described above, the learning data configuration may be processed in the rendering history information processing unit 130, and the rendering history information processing unit 130 may preprocess user metadata acquired from user information, rendering metadata and visual feature information mapped to the user metadata, and configure the preprocessed metadata and information as learning data.

Then, using the constructed learning data, when the first user information is input, the recommendation information providing device 100 constructs a rendering history-based relationship learning model that trains relationship information to allow visual feature information and condition metadata suitable for the first user information to be output (S107).

Thereafter, the recommendation information providing device 100 acquires new user information from the content service providing device 200 (S109), and applies the new user information to the relationship learning model to acquire recommendation rendering metadata and recommended visual feature information (S111).

Accordingly, the content service providing device 200 receives the acquired recommendation rendering metadata to configure product or interior recommendation information based on the acquired recommendation rendering metadata (S113).

Then, the content service providing device 200 processes the recommended content service interface to be output from the user terminal using the configured recommendation information (S115).

Here, the steps S113 and S115 may also be performed through the information providing unit 160 of the recommendation information providing device 100.

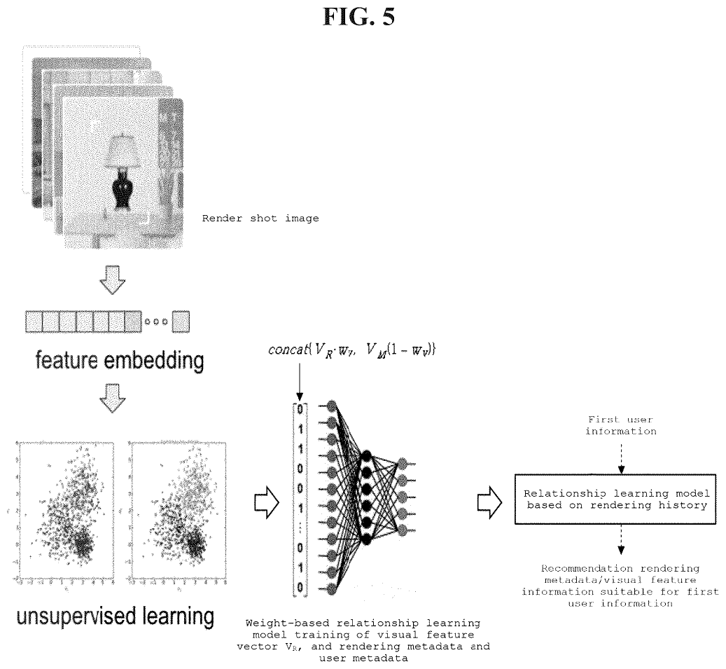

FIG. 5 is a diagram schematically explaining a process of constructing a relationship learning model based on a rendering history according to an embodiment of the present disclosure.

As shown in FIG. 5, users may render a render shot image on the user terminal 300 through the use of various rendering services, and these render shot images may be produced in the form of a visual feature vector V_{R} by performing unsupervised learning classification through an embedding process of feature information.

In addition, the relationship learning model training unit 140 according to an embodiment of the present disclosure may train a relationship learning model between a visual feature vector V_{R}, and rendering metadata and user metadata, thereby constructing a relationship learning model based on rendering history.

In addition, the relationship learning model training unit 140 may use a weight-based concatenation function when training a relationship learning model between rendering metadata and user metadata, and a visual feature vector, which may be calculated as a functional equation: concat{V_{R}*wᵥ, V_{M}(1−wᵥ)}, by setting a first weight (wᵥ) corresponding to the visual feature vector.

In the concatenation function (concat) operation, V_{R} may include feature vectors of render shots extracted from various angles, wᵥ may indicate a weight set in response to visual feature information, and V_{M} may indicate a second weight set in response to rendering metadata and user metadata, and the second weight may be included in the form of (1−wᵥ).

The first and second weights may be hyperparameters that vary depending on at which level the importance of the visual feature information is set when constructing the relationship learning model in the relationship learning model training unit 140, which may be determined according to the setting information of the relationship learning model training unit 140.

Meanwhile, the variables that configure the user metadata may also have their respective weights set, and for example, when price and style information for each category are included therein, which information has the highest weight may be set in advance. Furthermore, in order to set the price and category weights of user metadata, the user information collection unit 115 may normalize product prices within the same category style for the content purchased by the user and the number of category styles purchased compared to a total number of category styles, and determine respective price and category weight variables based on the normalized values.

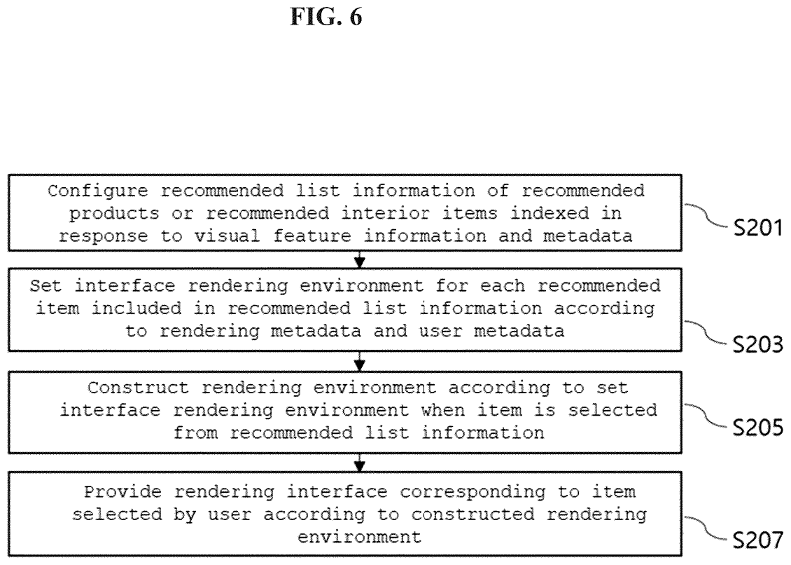

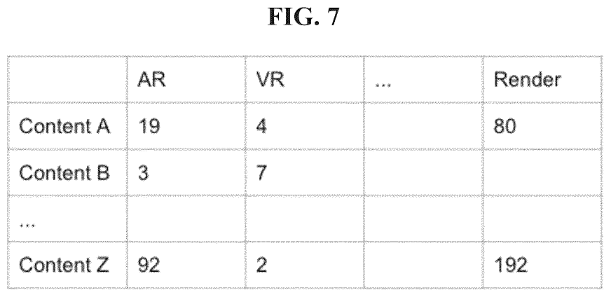

FIG. 6 is a flowchart for explaining an operation of a recommendation information providing device according to another embodiment of the present disclosure, and FIG. 7 is a diagram illustrating a rendering interface environment information table according to an embodiment of the present disclosure.

As described above, the recommendation information providing device 100 according to an embodiment of the present disclosure may identify user preference rendering environment information based on the prediction of rendering metadata and user metadata, which may be used to vary the recommended item rendering interface environment on the user terminal 300.

For example, as shown in FIG. 7, statistical information on the service rendering environment usage rate for each content may be constructed in response to the user, and for example, may collected and analyzed as AR rendering (AR) statistics, VR rendering (VR) statistics, 2D rendering (render) statistics, and the like, and configured with user metadata through a normalization process, converted into an input feature vector of the relationship learning model training unit 140, and input thereto.

In addition, the recommendation information providing device 100 according to an embodiment of the present disclosure may process a rendering environment providing service using such user metadata.

More specifically, referring to FIG. 6, first, the recommendation information providing device 100 configures recommended list information of recommended products or recommended interior items indexed in response to visual feature information and metadata (S201).

In order to configure recommended list information, the recommendation information providing device 100 may use a database in the content service providing device 200.

Then, the recommendation information providing device 100 sets an interface rendering environment for each recommended item included in the recommended list information according to rendering metadata and user metadata (S203). Accordingly, interface rendering environment setting information may be provided to the user terminal 300.

Accordingly, when an item is selected from the recommended list information, the user terminal 300 may construct a rendering environment according to the set interface condition (S205), and the user terminal 300 may provide a rendering interface corresponding to the item selected by the user according to the constructed rendering environment.

For example, as described above, the rendering interface environment may be illustrated as AR, VR, two-dimensional display rendering, and the like, and content corresponding to the user's preferred visual feature information according to the user metadata may be output through the user's preferred rendering environment so as to improve recommendation accuracy as well as the user's service satisfaction.

Meanwhile, various embodiments described herein may be implemented in a computer-readable recording medium, for example, using software, hardware, or a combination thereof. According to hardware implementation, the embodiments described herein may be implemented using at least one of application specific integrated circuits (ASICs), digital signal processors (DSPs), digital signal processing devices (DSPDs), programmable logic devices (PLDs), and field programmable gate arrays (FPGAs), processors, controllers, micro-controllers, microprocessors, and electrical units for performing functions. In some cases, such embodiments may be implemented by a control unit.

Furthermore, the embodiments described above may be implemented as hardware elements, software elements, and/or a combination of hardware elements and software elements. For example, the devices, methods and elements described in the embodiments may be implemented using, for example, one or more general-purpose or special-purpose computers, such as a processor, a controller, a central processing unit (CPU), a graphics processing unit (GPU), an arithmetic logic unit (ALU), a digital signal processor, a microcomputer, a field programmable gate array (FPGA), a programmable logic unit (PLU), a microprocessor, application specific integrated circuits (ASICs), or any other device capable of executing and responding to instructions.

The foregoing method according to the present disclosure may be produced as a program to be executed on a computer and stored in a computer-readable recording medium, and examples of computer-readable recording media include a ROM, a RAM, a CD-ROM, a magnetic tape, a floppy disk, an optical data storage device, and the like, and also include those implemented in the form of carrier waves (e.g., transmission over the Internet).

The computer-readable recording medium may be distributed over computer systems connected via a network, and stored and executed as computer-readable codes in a distributed manner. Furthermore, functional programs, codes, and code segments for implementing the method may be easily inferred by programmers in the technical field to which the present disclosure pertains.

While the preferred embodiments of the present disclosure have been shown and described above, it will be of course understood by those skilled in the art that various modifications may be made without departing from the gist of the disclosure as defined in the following claims, and it is to be noted that those modifications should not be understood individually from the technical concept and prospect of the present disclosure.

1. A method of operating a recommendation information providing device, the method comprising:
acquiring first user information;
applying the first user information to a relationship learning model based on a rendering history corresponding to content; and
providing content recommendation information corresponding to the first user information using the output information of the learning model.

2. The method of claim 1, wherein the relationship learning model is a model in which rendering-based visual feature information of the content according to the provision of a content service is pre-trained in response to metadata feature information and user metadata of the content.

3. The method of claim 2, wherein the metadata feature information of the content is configured from at least one of rendering condition metadata acquired in connection with rendering of the content, model information metadata corresponding to the content, and product information metadata corresponding to the content.

4. The method of claim 3, wherein the rendering condition metadata comprises first metadata corresponding to a detailed attribute of the content, second metadata corresponding to a rendering condition of the content, and third metadata corresponding to a surrounding environment in which the content is rendered.

5. The method of claim 4, wherein the first metadata comprises at least one of a length, a color, a category, and a type corresponding to the detailed attribute of the content,
wherein the second metadata comprises at least one of whether it is virtual reality rendering, whether it is augmented reality rendering, an illumination condition, a camera position, a camera focus, a camera angle, and whether it is composite scene content corresponding to the rendering state of the content, and
wherein the third metadata comprises at least one of region type information, region size information, and region material indexing information corresponding to the rendered surrounding environment.

6. The method of claim 1, wherein the user recommendation information comprises at least one of basic user information collected in response to content, rendering interface input information corresponding to the basic user information, preference input information, purchase input information, evaluation input information, and category input information.

7. The method of claim 1, wherein the visual feature information comprises a visual feature vector acquired by applying one or more rendering images acquired in response to the content to a deep learning network.

8. The method of claim 7, wherein the one or more rendering images comprise images in which the content or a scene image including the content is rendered for each preset three-dimensional viewpoint.

9. The method of claim 8, wherein the visual feature information comprises a visual feature vector extracted from the deep learning network according to geometric structure information and color information according to the three-dimensional viewpoint of the rendering image.

10. The method of claim 1, wherein the providing of the content recommendation information comprises:
indexing recommended products or recommended interior items in response to recommended visual feature information and recommended condition metadata output from the learning model;
constructing recommended item list information corresponding to the first user information using the recommended products or recommended interior items; and
providing the recommended item list information to a user terminal corresponding to the first user information.

11. The method of claim 10, further comprising:
identifying rendering interface environment information corresponding to each item in the recommended item list; and providing the rendering interface environment information to the user terminal to process the recommended item selected by the user terminal to be output through a rendering environment constructed according to the rendering interface environment information.

12. A content recommendation information providing device, the device comprising:
a user information collection unit that acquires first user information;
a model-based recommendation data generation unit that applies the first user information to a relationship learning model based on a rendering history corresponding to content; and
an information providing unit that provides content recommendation information corresponding to the first user information using the output information of the learning model.

13. The device of claim 12, wherein the relationship learning model is a model in which rendering-based visual feature information of the content according to the provision of a content service is pre-trained in response to metadata feature information and user metadata of the content.

14. The device of claim 13, further comprising:
a history information processing unit that collects history information corresponding to the content from pre-provided content service information,
wherein the history information processing unit configures metadata feature information of the content from at least one of rendering condition metadata acquired in connection with rendering of the content, model information metadata corresponding to the content, and product information metadata corresponding to the content.

15. The device of claim 14, wherein the rendering condition metadata comprises first metadata corresponding to an attribute of the content, second metadata corresponding to a rendering condition of the content, and third metadata corresponding to a surrounding environment in which the content is rendered.

16. The device of claim 15, wherein the first metadata comprises at least one of a length, a color, a category, and a type corresponding to the attribute of the content,
wherein the second metadata comprises at least one of whether it is virtual reality rendering, whether it is augmented reality rendering, an illumination setting, a camera position, a camera focus, a camera angle, and whether it is composite scene content corresponding to the rendering condition of the content, and
wherein the third metadata comprises at least one of region type information, region size information, and region material information corresponding to the rendered surrounding environment.

17. The device of claim 12, further comprising:
a history information processing unit that collects history information corresponding to the content from pre-provided content service information,
wherein the visual feature information comprises a visual feature vector acquired by applying one or more rendering images acquired in response to the content from the history information to a deep learning network.

18. The device of claim 17, wherein the one or more rendering images comprise images in which the content or a scene image including the content is rendered for each preset three-dimensional viewpoint.

19. The device of claim 18, wherein the visual feature information comprises a visual feature vector extracted from the deep learning network according to geometric structure information and color information according to the three-dimensional viewpoint of the rendering image.

20. The device of claim 1, wherein the information providing unit indexes recommended products or recommended interior items in response to recommended visual feature information and recommended condition metadata output from the learning model, constructs recommended item list information corresponding to the first user information using the recommended products or recommended interior items, provides the recommended item list information to a user terminal corresponding to the first user information, identifies rendering interface environment information corresponding to each item in the recommended item list, and provides the rendering interface environment information to the user terminal to process the recommended item selected by the user terminal to be output through a rendering environment constructed according to the rendering interface environment information.
